(19) United States
(12) Patent Application Publication
(10) Pub. No.: US 2010/0069551 A1
(43) Pub. Date: Mar. 18, 2010

(54) ULTRAHYDROPHOBIC COATINGS

(75) Inventors: Oliver Minge, Munich (DE); Peter Ball, Emmerting (DE); Sabine Delica, Munich (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 12/513,618

(22) PCT Filed: Nov. 8, 2007
(86) PCT No.: PCT/EP2007/062068

§ 371 Date: May 5, 2009

(30) Foreign Application Priority Data
Nov. 16, 2006 (DE) 10 2006 054 158.8

(51) Int. Cl. C08K 3/22; C08K 3/10; C08L 83/07

(52) U.S. Cl. 524/406; 524/408; 524/413; 524/430; 524/432; 524/437; 524/547

(57) ABSTRACT

Ultrahydrophobic coatings are prepared by coating a substrate with a coating system containing an addition polymer containing moieties derived from a mono- or polyethylenically unsaturated organopolysiloxane, and hydrophillic particles.

The present invention relates to polymer-particle admixtures, their preparation and their use.

Ultrahydrophobic coatings that endow a surface with self-cleaning or anti-soiling properties are an extensively researched subject and of high economic value. A surface that is nonwettable by water is associated with reduced soiling and reduced cleaning, reduced colonization by algae, fungi or microorganisms, a more attractive visual appearance and also altogether appreciable lower maintenance costs. Such surfaces thus possess better functionality and a longer useful life compared with conventional, at least partially wettable surfaces.

Surfaces which are hard to wet, i.e. ultrahydrophobic surfaces, are known. In nature, they are frequently found on leaves of plants, the best known of which is the lotus flower, but also common or garden cabbage and nasturtium have such surfaces on their leaves. The principle of these surfaces is described in EP 772514, the claims of which are to a self-cleaning surface whose surface structure includes elevations and depressions, the elevations being between 5 and 100 micrometers in size and spaced between 5 and 200 micrometers apart. The elevations consist of a hydrophobic material. EP 772514, however, does not claim any substructuring of these elevations and depressions. A person skilled in the art now knows that an ultrahydrophobic effect requires structuring through elevations and depressions in the micrometer region but also nanostructuring of the individual elevations and depressions.

Two approaches are customary to artificially produce such surfaces:

The first approach involves the subsequent structuring of a previously smooth surface. Methods from plastics processing are used, in particular the negative molding of master structures, for example by extrusion, injection molding or embossing. For instance, DE 10210673 describes inter alia the production of such surfaces through modified injection-molding processes. Similarly, processes known in the semiconductor arts, i.e., lithographic methods, are known for producing ultrahydrophobic surfaces. The requisite structuring of the surfaces is effected via masks, irradiation of photoresistant materials with high-energy light, and also through etching operations. One example thereof is DE 10138036. It describes the production of ultrahydrophobic surfaces by means of photoresistant materials and laser light in the UV region.

The second approach involves the application of particles to a smooth surface in such a way that these particles, after application, produce a correct, ultrahydrophobicity-conferring surface texture. The systems used generally always consist of a physically or chemically filming binder and of particles, the particles being applied together with the binder or subsequently.

WO 02/049980 teaches for example a system consisting of at least partially hydrophobicized particles in the nanometer region and an inorganic or organic binder.

EP 1043380 describes a system of fluorinated particles in the nanometer region together with a fluorinated polymer as binder.

EP 1153987 describes a system composed of a hydrophobic porous particle and a hydrophobic binder selected from polyolefins which may contain polyalkylene oxide groups.

DE 102004062739 describes a system consisting of hydrophobic particles and a binder wherein the binder used is a UV-curing acrylate varnish. The binder and the particles are applied in separate operations.

WO 02/055446 describes a system consisting of an acrylic acid-ethylene copolymer and a hydrophobicized fumed silica.

DE 10118352 describes a system consisting of an acrylate copolymer as binder and hydrophobicized silica as particles.

WO 2004/014575 describes a system based on a powder coating which is applied by powder spraying together with the particle. The particles used are particles composed of hydrophobic materials, or specially hydrophobicized particles.

EP 1475426 finally describes a system consisting of a silicone wax as binder and hydrophobic particles.

All the systems in question rely on the use of hydrophobic particles and often additionally also a hydrophobic binder or a posthydrophobicization. Hydrophobic particles are among the most costly components of the system. In general, they first have to be produced from hydrophilic particles in an extra operation, by surface-functionalizing reactions. This requires the use of costly reagents, for example special organofunctional silanes, and generally also gives rise to processing waste. On the other hand, already hydrophobic materials, polyolefin waxes are an example, generally first have to be brought into a particulate (micronized) form.

The present invention provides a coating system comprising an organosilicone copolymer (O) obtainable by free-radical polymerization of

A) ethylenically unsaturated monomers selected from (meth)acrylic esters, vinyl esters, vinylaromatics, olefins, 1,3-dienes and vinyl ethers, and
B) mono- or polyethylenically unsaturated polyorganosiloxanes, and
C) optionally ethylenically unsaturated auxiliary monomers, and hydrophilic particles (P).

The inventors found that, surprisingly, even exclusively hydrophilic particles (P) are sufficient to produce a very markedly ultrahydrophobic surface when the specific organosilicone copolymer (O) is at the same time used as binder.

The organosilicone copolymer (O) is obtainable by free-radical copolymerization of standard building blocks of polymer chemistry, for example acrylates and styrenes together with ethylenically unsaturated polyorganosiloxanes B). The polyorganosiloxanes B) may surprisingly comprise just a very minor proportion of the entire organosilicone copolymer (O).

The coating system composed of (O) and (P) may be present in the form of a powder coating, in organic solution or in aqueous dispersion. In the case of the coating system composed of (O) and (P) being present in aqueous dispersion, the polymer is ideally self-dispersible and no external dispersing auxiliaries need be used.

Preferred monomers A) from the group of acrylic esters or methacrylic esters are esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate. Particular preference is given to methyl acrylate, methyl methacrylate, n-butyl acrylate, n-butyl methacrylate, isobutyl acrylate, t-butyl acrylate, 2-ethylhexyl acrylate and norbornyl acrylate.

Preferred ethylenically unsaturated monomers A) from the group of vinyl esters are those with carboxylic acid radicals having 1 to 15 carbon atoms. Particular preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 carbon atoms, for example VeoVa9® or VeoVa10® (from Resolution). Vinyl acetate is particularly preferred.

Preferred as vinylaromatics A) are styrene, alpha-methylstyrene, the isomeric vinyltoluenes and vinylxylenes and also divinylbenzenes. Styrene is particularly preferred.

Methyl vinyl ether is an example of a preferred vinyl ether A).

The preferred olefins A) are ethane, propene, 1-alkylethenes and also polyunsaturated alkenes, and the preferred dienes are 1,3-butadiene and isoprene. Ethene and 1,3-butadiene are particularly preferred.

Particular preference for use as monomers A) is given to one or more monomers from the group of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene, 1,3-butadiene. Particular preference for use as monomers A) is also given to mixtures of n-butyl acrylate and 2-ethylhexyl acrylate and/or methyl methacrylate; mixtures of styrene and one or more monomers from the group consisting of methyl acrylate, ethyl acrylate, propyl acrylate, n-butyl acrylate and 2-ethylhexyl acrylate; mixtures of vinyl acetate and one or more monomers from the group consisting of methyl acrylate, ethyl acrylate, propyl acrylate, n-butyl acrylate, 2-ethylhexyl acrylate and optionally ethylene; mixtures of 1,3-butadiene and styrene and/or methyl methacrylate.

Preferred mono- or polyethylenically unsaturated polyorganosiloxanes B) have the general formula [1]

(SiO_{4/2})ₖ(R¹SiO_{3/2})ₘ(R¹₂SiO_{2/2})ₚ(R¹₃SiO_{1/2})_{q}[O_{1/2}SiR³₂-L-X]ₛ[O_{1/2}H]ₜ [1]

where
L represents a bivalent optionally substituted aromatic, heteroaromatic or aliphatic radical (CR⁴₂)_{b},
R¹, R³, R⁴ each represent a hydrogen atom or a monovalent optionally —CN—, —NCO—, —NR²₂—, —COOH—, —COOR²—, —PO(OR²)₂—, -halogen-, -acryloyl-, -epoxy-, —SH—, —OH— or —CONR²₂-substituted C₁-C₂₀ hydrocarbyl radical or C₁-C₂₀ hydrocarbyloxy radical in which in each case one or more mutually nonadjacent methylene units may be replaced by groups —O—, —CO—, —COO—, —OCO— or —OCOO—, —S—, or —NR²— and in each of which one or more mutually nonadjacent methine units may be replaced by groups —N═, —N═N—, or —P═,
X represents an ethylenically unsaturated radical,
R² represents hydrogen or a monovalent optionally substituted hydrocarbyl radical,
b represents 0 or integral values,
s represents integral values of at least 1,
t represents 0 or integral values,
k+m+p+q represent integral values of at least 2.

Preferred polyorganosiloxanes B) are those whose C₁-C₂₀ hydrocarbyl radicals and C₁-C₂₀ hydrocarbyloxy radicals R¹, R³, R⁴ can be aliphatically saturated or unsaturated, aromatic, straight chain or branched. R¹, R³, R⁴ preferably have 1 to 12 atoms, in particular 1 to atoms, preferably just carbon atoms, or one alkoxy oxygen atom and otherwise just hydrogen atoms. Preferably, R¹, R³, R⁴ are straight-chain or branched C₁-C₆ alkyl radicals or phenyl radicals. Particular preference is given to the radicals methyl, ethyl, phenyl and vinyl.

Preferably, R³ is a methyl radical and R⁴ is hydrogen.

X is preferably an ethylenically unsaturated radical of the vinyl (—C₂H₃), acryloyl (—OCOC₂H₃) or methacryloyl (—OCOC₂H₂CH₃) type.

Preferably, b is not more than 50, particularly not more than 10. In particularly preferred embodiments, b is 0, 1, 2 or 3.

The polyorganosiloxane B) of the general formula [1] can be linear, cyclic, branched or crosslinked. The sum total of k, m, p, q, s and t is preferably from 3 to 20 000, in particular from 8 to 1000.

A preferred version of a polyorganosiloxane B) of the general formula [1] is a linear polyorganosiloxane which consists exclusively, or nearly exclusively, of R₂SiO_{2/2} units; the silicone shall be almost exclusively composed of difunctional units p. Preferably, the proportion of p in relation to the sum total of k, m, p, q is at least 95% and more preferably it is >95%. In this case, the number of ethylenically unsaturated groups per molecule is preferably one or two. Very particular preference is given to α,ω-divinylpolydimethylsiloxanes and also α-methacryloyloxymethylpolydimethylsiloxanes and α,ω-bis(methacryloyloxymethyl)polydimethylsiloxanes. More particularly, k and m each represent 0 and q represents 0 or 1.

A further preferred version of a polyorganosiloxane B) of the general formula [1] is an organosilicone resin. This can consist of two or more units as described in the general formula [1], in which case the mole percentages of the units present are indicated by the indices k, m, p, q. k+m shall be >0. Preference here is given to using polysiloxane resins B) in which k+m>50%, based on the sum total of k, m, p, q. Particular preference is given to resins for which k+m>90%.

A further preferred version of a polyorganosiloxane B) of the general formula [1] is an organosilicone resin which consists exclusively or nearly exclusively of SiO_{4/2} units; k shall be greater than m+p+q. The proportion of k in relation to the sum total of k, m, p, q is preferably at least 51% and more preferably it is >95% or in the range from 55 to 65%.

If desired, 0.1% to 20% by weight, based on the total weight of monomers A), can additionally be copolymerized of each of the ethylenically unsaturated auxiliary monomers C). Preference is given to using 0.5% to 2.5% by weight per representative of an auxiliary monomer C). Altogether, the sum total of all auxiliary monomers C) may comprise up to 20% by weight of the monomer mixture of A), B) and C), preferably there are in total less than 10% by weight of auxiliary monomers C). Examples of auxiliary monomers C) are ethylenically unsaturated mono- and dicarboxylic acids, preferably acrylic acid, methacrylic acid, fumaric acid and maleic acid; ethylenically unsaturated carboxylic acid amides and nitriles, preferably acrylamide and acrylonitrile; mono- and diesters of fumaric acid and maleic acid such as the diethyl and diisopropyl esters, and also maleic anhydride, ethylenically unsaturated sulfonic acids and their salts, preferably vinylsulfonic acid, 2-acrylamido-2-methylpropane-sulfonic acid. Further examples are precrosslinking comonomers such as polyethylenically unsaturated comonomers, examples being divinyl adipate, diallyl maleate, allyl methacrylate or triallyl cyanurate, and postcrosslinking comonomers, examples being acrylamidoglycolic acid (AGA), methyl methylacrylamido-glycolate (MAGME), N-methylolacrylamide (NMA), N-methylolmethacrylamide, N-methylolallyl carbamate, alkyl ethers such as the isobutoxy ether or ester of N-methylolacrylamide, of N-methylolmethacrylamide and of N-methylolallyl carbamate. Also suitable are epoxide-functional ethylenically unsaturated comonomers such as glycidyl methacrylate and glycidyl acrylate. There may also be mentioned ethylenically unsaturated monomers having hydroxyl or CO groups, examples being hydroxyalkyl methacrylates and acrylates such as hydroxyethyl acrylate, hydroxypropyl acrylate, hydroxybutyl acrylate, hydroxyethyl methacrylate, hydroxypropyl methacrylate or hydroxybutyl methacrylate, and also compounds such as diacetoneacrylamide and acetylacetoxyethyl acrylate or methacrylate. There may further be mentioned copolymerizable ethylenically unsaturated silanes, for example vinylsilanes such as vinyltrimethoxysilane or vinyltriethoxysilane or (meth)acryloylsilanes, for example the silanes marketed by Wacker-Chemie AG, Munich, Germany under the names of GENIOSIL® GF-31 (methacryloyloxypropyltrimethoxysilane), XL-33 (methacryloyloxymethyltrimethoxysilane), XL-32 (methacryloyloxymethyldimethylmethoxysilane), XL-34 (methacryloyloxymethylmethyldimethoxysilane) and XL-36 (methacryloyloxymethyltriethoxysilane).

The choice of monomers A), or to be more precise the choice of the weight fractions for the monomers A), B) and the comonomers C), is preferably made such that, in general, the resulting glass transition temperature Tg is ≦60° C., preferably in the range from −50° C. to +60° C. The glass transition temperature Tg of the organosilicone copolymers (O) can be determined in a known manner by means of differential scanning calorimetry (DSC). Tg can also be approximately predicted by means of the Fox equation. According to Fox T. G., Bull. Am. Physics Soc. 1, 3, page 123 (1956), the following equation holds: 1/Tg=x1/Tg1+x2/Tg2+ . . . +xn/Tgn, where xn represents the mass fraction (% by weight/100) of the monomer n, and Tgn is the glass transition temperature in Kelvin of the homopolymer of the monomer n. Tg values for homopolymers are reported in Polymer Handbook 2^{nd} edition, J. Wiley & Sons, New York (1975). The amount of monomers A) used is preferably at least parts by weight and more preferably at least 65 parts by weight, per 100 parts by weight of the ethylenically unsaturated monomers A), B) and C). The amount used of monomer B) is preferably in the range from 1 to 50 parts by weight, more preferably up to 30 parts by weight and, in particular, not more than 25 parts by weight. The amount of monomer C) used is preferably up to 20 parts by weight and more preferably not more than 10 parts by weight.

The organosilicone copolymers (O) are prepared by means of the methods of free-radical polymerization, and the preparation may take place without a solvent, in organic solution or in organic dispersion, as will be familiar to a person skilled in the art. The synthesis is likewise possible in an aqueous medium by following the heterophase techniques of suspension, emulsion or miniemulsion polymerization which are familiar to a person skilled in the art (cf. for example Peter A. Lovell, M. S. El-Aasser, “Emulsion Polymerization and Emulsion Polymers” 1997, John Wiley and Sons, Chichester). Preference is given to an addition polymerization in organic solution and very particular preference is given to an addition polymerization in an at least partially water-miscible solvent or solvent mixture, examples being isopropanol, isopropanol-ethyl acetate mixtures, methoxypropyl acetate-isopropanol mixtures.

The polymerization medium is ideally at the same time the medium in which the system of (O) and (P) is subsequently prepared or used. However, an exchange of solvents is also possible; more particularly, converting addition polymers obtained without a solvent into organic solutions or replacing an organic solvent by an aqueous medium is preferred.

The reaction temperatures range from 0° C. to 150° C., preferably from 20° C. to 130° C. and more preferably from 30° C. to 120° C. The addition polymerization can be carried out batchwise or continuously, with initial charging of all or individual constituents of the reaction mixture, with partial initial charging and subsequent metered addition of individual constituents of the reaction mixture, or by following the metering process without initial charge. All metered additions are preferably at the rate of the consumption of the respective component. Particular preference is given to an addition polymerization in which the silicone building blocks are initially charged and the other reactive constituents of the addition polymerization are added by metered addition.

The addition polymerization is initiated by means of the customary initiators or redox initiator combinations. Examples of initiators are the sodium, potassium and ammonium salts of peroxodisulfuric acid, hydrogen peroxide, t-butyl peroxide, t-butyl hydroperoxide, potassium peroxodiphosphate, t-butyl peroxopivalate, cumene hydroperoxide, t-butyl peroxobenzoate, isopropylbenzene monohydroperoxide and azobisisobutyronitrile. The recited initiators are preferably used in amounts of 0.01% to 4.0% by weight, based on the total weight of the comonomers A), B) and C). The redox initiator combinations used comprise abovementioned initiators combined with a reducing agent. Suitable reducing agents are sulfites and bisulfites of monovalent cations, for example sodium sulfite, the derivatives of sulfoxylic acid such as zinc or alkali metal formaldehydesulfoxylates, for example sodium hydroxymethanesulfinate and ascorbic acid. The amount of reducing agent is preferably in the range from 0.15% to 3% by weight of the comonomers A), B) and C) used. Small amounts of a metal compound which is soluble in the polymerization medium and the metal component of which is redox active under the polymerization conditions can be additionally introduced, such a metal compound being based on iron or vanadium for example. Particularly preferred initiators are t-butyl peroxopivalate, and t-butyl peroxobenzoate, and also the peroxide/reducing agent combinations of ammonium persulfate/sodium hydroxymethanesulfinate and potassium persulfate/sodium hydroxymethanesulfinate. An overview of further suitable initiators in addition to the representatives just described is to be found in “Handbook of Free Radical Initiators”, E. T. Denisov, T. G. Denisova, T. S. Pokidova, 2003, Wiley Verlag.

Preferred particles (P) are selected from hydrophilic silicon oxides and metal oxides MO. The particles (P) are equipped on their surface with M-OH or M-O-M functions, via which they are able to positively interact with polar media and groups. More particularly, the oxides MO have not been hydrophobicized via surface-functionalizing reagents, for example chlorosilanes.

Among the metal oxides MO, the oxides of the metals aluminum, titanium, zirconium, tantalum, tungsten, hafnium, zinc and tin are preferred. Among the metal oxides MO, aluminum oxides such as corundum, aluminum mixed oxides with other metals and/or silicon, titanium oxides, zirconium oxides, iron oxides are particularly preferred.

Among the silicon oxides MO, it is colloidal silica, fumed silica, precipitated silica, natural silicas, for example silica gel and diatomaceous earth and silica sols which are preferred.

It is also possible to use the metals M with an oxidized surface, and zeolites (a listing of suitable zeolites is to be found in Ch. Baerlocher, W. M. Meier, D. H. Olson, Atlas of Zeolite Framework Types, 5^{th} edition, 2001, Elsevier, Amsterdam), silicates, aluminates, aluminophosphates, titanates and aluminum sheet-silicates (e.g., bentonites, montmorillonites, smectites, hectorites), in which case the particles (P) preferably have a specific surface area of 0.1 to 1000 m²/g and more preferably have a specific surface area of 1 to 500 m²/g (measured by following the BET method of DIN 66131 and 66132).

The particles (P), the average diameter of which is preferably not more than 50 μm and more preferably not more than 25 μm, can be present as aggregates (defined according to DIN 53206) and agglomerates (defined according to DIN 53206), which depending on the external shearing load (due to the measuring conditions for example) can have sizes in the range from 1 to 1000 μm.

Particular preference for use as particles (P) is given to fumed silica, which is prepared in a flame reaction from volatile silicon compounds, for example from silicon tetrachloride or methyldichlorosilane, or hydrotrichlorosilane or hydromethyldichlorosilane, or other methylchlorosilanes or alkylchlorosilanes, alone or mixed with hydrocarbons, or any desired volatilizable or sprayable mixtures of organosilicon compounds, as mentioned, and hydrocarbons, for example in a hydrogen-oxygen flame, or else a carbon monoxide-oxygen flame. Silica production can take place selectively with and without addition of water, for example in the purifying step; preferably, no water is added.

Fumed silica or silicon dioxide is known for example from Ullmann's Enzyklopädie der Technischen Chemie 4^{th} edition, Volume 21, page 464.

Unmodified fumed silica has a specific BET surface area (measured in accordance with DIN EN ISO 9277/DIN 66132) in the range from 10 m²/g to 600 m²/g, preferably in the range from 50 m²/g to 400 m²/g.

The apparent density of the unmodified fumed silica after tamping in accordance with DIN EN ISO 787-11 is preferably in the range from 10 g/l to 500 g/l, more preferably in the range from 20 g/l to 200 g/l and even more preferably in the range from 30 g/l to 100 g/l.

The fumed silica preferably has a fractal surface dimension of preferably not more than 2.3, more preferably of not more than 2.1 and particularly in the range from 1.95 to 2.05, the fractal surface dimension Dₛ here being defined as follows:

particle surface area A is proportional to particle radius R to the power of Dₛ.

The silica preferably has a fractal mass dimension Dₘ of preferably not more than 2.8, more preferably of not more than 2.3 and even more preferably in the range from 1.7 to 2.1, for example as reported in F. Saint-Michel, F. Pignon, A. Magnin, J. Colloid Interface Sci. 2003, 267, 314. The fractal mass dimension Dₘ here is defined as follows:

particle mass M is proportional to particle radius R to the power of Dₘ.

The unmodified silica preferably has an SiOH silanol surface density of less than 2.5 SiOH/nm², preferably less than 2.1 SiOH/nm², more preferably less than 2 SiOH/nm² and even more preferably in the range from 1.7 to 1.9 SiOH/nm², determined in accordance with a method given in G. W. Sears, Anal. Chem. 28 (1956) 1981. Silicas produced wet-chemically or at high temperature (>1000° C.) can be used. Pyrogenically produced silicas (fumed silicas) are particularly preferred. It is also possible to use hydrophilic silicas which come as-produced directly from the burner, have been temporarily stored or are already in commercial packaged form.

Mixtures of various metal oxides or silicas can be used, for example mixtures of metal oxides or silicas differing in BET surface area, or mixtures of metal oxides.

Particular preference for use as particles (P) is given to mixtures of fumed silicas with SiO₂ from diatoms, for example silica gel, kieselguhr, Celite® or diatomaceous earth.

The mass ratio of polymers (O)/particles (P) is preferably not more than 10/1, in particular not more than 10/2 and preferably at least 10/8, in particular at least 10/6.

If desired, one or more admixtures may additionally be added to the system of (O) and (P). Examples of admixtures are solvents or film-formation auxiliaries; mixtures of at least two organic solvents; pigment-wetting and dispersing agents; surface effect additives, for example those used to obtain textures such as the hammer finish or orange peel texture; antifoams; substrate-wetting agents; surface-leveling agents; adhesion promoters; release agents; further organic polymer not identical to the organic polymer of the present invention; surfactant; hydrophobic auxiliary material; a non-free-radically polymerizable polyorganosiloxane.

The system of particles (P) and polymers (O) is preferably produced by incorporating the particles (P) into a solution or dispersion of the polymer (O). This can be effected with the aid of methods familiar to a person skilled in the art, for example with the aid of a dissolver, with the aid of a rotor-stator appliance (for example Ultra-Turrax®) or with the aid of a speed mixer. Incorporation via a dissolver is particularly preferred.

The coating system is preferably used in the manufacture of hydrophobic coatings. The system thus produced can be applied in various ways to the surface to be treated. Possibilities are application by blade coater, by soft brush, by roller or by spraying device. Dip coating or spin coating methods are also possible. Once the coating has been applied it is ideally stabilized by thermal conditioning.

The coatings produced by application of the coating systems confer anti-soiling and ultrahydrophobic properties on substrates as different as glass, wood, textile fibers, paper fibers, stone, plastic and metal. Exemplary fields of application are the coating of house walls, house roofs, wind power plants, satellite dishes, tarpaulins, umbrellas, cabriolet covers, awnings or tablecloths.

All the above symbols in the above formulae each have their meanings independently of each other. The silicon atom is tetravalent in all the formulae.

In the examples which follow, unless otherwise stated, all amounts and percentages are by weight, all pressures are equal to 0.10 MPa (absolute) and all temperatures are equal to 20° C.

### EXAMPLES

### Example 1

### Preparation of a Polymer (O)

### Reaction Components:

| Component | Parts |
|---|---|
| Methoxypropyl acetate | 444 |
| Butyl methacrylate | 42 |
| Styrene | 29 |
| α-Methacryloyloxymethylpoly- | 10 |
| dimethylsiloxane (Mw ca. 1300) | |
| Hydroxypropyl methacrylate | 26 |
| Methacrylic acid | 2 |
| N-(Hydroxymethyl)acrylamide | 2 |

The solvent was initially charged, together with the silicone building block, in a jacketed reactor equipped with evaporative cooling, anchor stirrer and nitrogen inlet tube. The remaining monomers were added to the initial charge during 4 hours at 120° C. together with 1.6 parts of tert-butyl peroxybenzoate free-radical initiator. On completion of the addition a further 0.3 part of the free-radical initiator was added every half an hour in one go. A transparent solution having a solids content of 20% was obtained after altogether 5.5 hours of polymerization time. The polymer had a weight average molar mass of 25 000, as determined by GPC. TEM micrographs of the resulting film show a completely homogeneous distribution of the silicone building block.

### Example 2

### Preparation of a Polymer (O)

### Reaction Components:

| Component | Parts |
|---|---|
| Methoxypropyl acetate | 324.4 |
| Butyl methacrylate | 42 |
| Styrene | 29 |
| α-Methacryloyloxymethylpoly- | 8.1 |
| dimethylsiloxane (Mw ca. 3200) | |
| Hydroxypropyl methacrylate | 26 |
| Methacryloyloxypropyltri- | 4.3 |
| methoxysilane | |
| N-(Hydroxymethyl)acrylamide | 2 |

The solvent was initially charged, together with the silicone building block, in a jacketed reactor equipped with evaporative cooling, anchor stirrer and nitrogen inlet tube. The remaining monomers were added to the initial charge during 4 hours at 120° C. together with 1.6 parts of tert-butyl peroxybenzoate free-radical initiator. On completion of the addition a further 0.3 part of the free-radical initiator was added every half an hour in one go. A transparent solution having a solids content of 20% was obtained after altogether 5.5 hours of polymerization time. The polymer had a weight average molar mass of 40 000, as determined by GPC. TEM micrographs of the resulting film show a completely homogeneous distribution of the silicone building block.

### Example 3

### Preparation of a Polymer (O)

### Reaction Components:

| Component | Parts |
|---|---|
| Methoxypropyl acetate | 444 |
| Butyl methacrylate | 42 |
| Styrene | 29 |
| α,ω-Divinylpolydimethylsiloxane | 10 |
| (Mw ca. 10 000) | |
| Hydroxypropyl methacrylate | 26 |
| Methacrylic acid | 2 |
| N-(Hydroxymethyl)acrylamide | 2 |

The solvent was initially charged, together with the silicone building block, in a jacketed reactor equipped with evaporative cooling, anchor stirrer and nitrogen inlet tube. The remaining monomers were added to the initial charge during 4 hours at 120° C. together with 1.6 parts of tert-butyl peroxybenzoate free-radical initiator. On completion of the addition a further 0.3 part of the free-radical initiator was added every half an hour in one go. A transparent solution having a solids content of 20% was obtained after altogether 5.5 hours of polymerization time. The polymer had a weight average molar mass of 25 000, as determined by GPC. TEM micrographs of the resulting film show a partially phase-separated copolymer which, however, no longer contains any unpolymerized silicone constituents.

### Example 4

### Preparation of an Inventive Polymer (O)

### Reaction Components:

| Component | Parts |
|---|---|
| Methoxypropyl acetate | 442.8 |
| Butyl methacrylate | 42 |
| Styrene | 29 |
| α-Methacryloyloxymethylpoly- | 11.7 |
| dimethylsiloxane (Mw ca. 3200) | |
| α,ω-Bis(methacryloyloxymethyl)- | 6 |
| polydimethylsiloxane | |
| (Mw ca. 3300) | |
| Divinylbenzene | 0.6 |
| Methacryloyloxymethyldimethyl- | 2.4 |
| methoxysilane | |
| Hydroxypropyl methacrylate | 26 |
| N-(Hydroxymethyl)acrylamide | 2 |

The solvent was initially charged, together with the silicone building block, in a jacketed reactor equipped with evaporative cooling, anchor stirrer and nitrogen inlet tube. The remaining monomers were added to the initial charge during 4 hours at 120° C. together with 1.6 parts of tert-butyl peroxybenzoate free-radical initiator. On completion of the addition a further 0.3 part of the free-radical initiator was added every half an hour in one go. A transparent solution having a solids content of 20% was obtained after altogether 5.5 hours of polymerization time. The polymer had a weight average molar mass of 51 000, as determined by GPC. TEM micrographs of the resulting film show a completely homogeneous distribution of the silicone building block.

### Example 5

### Preparation of an Inventive Polymer (O)

### Reaction Components:

| Component | Parts |
|---|---|
| Methoxypropyl acetate | 400.8 |
| Butyl acrylate | 44 |
| Methyl methacrylate | 44 |
| α-Methacryloyloxymethylpoly- | 10.2 |
| dimethylsiloxane (Mw ca. 3200) | |
| Methacryloyloxypropyl- | 1 |
| trimethoxysilane | |
| N-(Hydroxymethyl)acrylamide | 2 |

The solvent was initially charged, together with the silicone building block, in a jacketed reactor equipped with evaporative cooling, anchor stirrer and nitrogen inlet tube. The remaining monomers were added to the initial charge during 4 hours at 120° C. together with 1.6 parts of tert-butyl peroxybenzoate free-radical initiator. On completion of the addition a further 0.3 part of the free-radical initiator was added every half an hour in one go. A transparent solution having a solids content of 20% was obtained after altogether 5.5 hours of polymerization time. The polymer had a weight average molar mass of 33 000, as determined by GPC. TEM micrographs of the resulting film show a completely homogeneous distribution of the silicone building block.

### Example 6

### Preparation of an Inventive Polymer (O)

### Reaction Components:

| Component | Parts |
|---|---|
| Isopropanol/ethyl acetate 9/1 | 400 |
| Vinyl acetate | 70 |
| Itaconic acid | 5 |
| α,ω-Divinylpolydimethylsiloxane | 10 |
| (Mw ca. 10 000) | |
| Vinyltrimethoxysilane | 2 |
| N-(Hydroxymethyl)acrylamide | 2 |

The solvent was initially charged, together with the silicone building block, in a jacketed reactor equipped with evaporative cooling, anchor stirrer and nitrogen inlet tube. The vinyl acetate was added to the initial charge during 4 hours at 120° C. together with 1.6 parts of tert-butyl peroxypivalate free-radical initiator. On completion of the addition a further 0.3 part of the free-radical initiator was added every half an hour in one go. A tyndallizing solution having a solids content of 17% was obtained after altogether 5.5 hours of polymerization time. The polymer had a weight average molar mass of 35 000, as determined by GPC. TEM micrographs of the resulting film show a microphase separation in the micrometer region.

### Example V1

### Preparation of a Non-Inventive Polymer

### Reaction Components:

| Component | Parts |
|---|---|
| Methoxypropyl acetate | 444 |
| Butyl methacrylate | 45 |
| Styrene | 32 |
| Hydroxypropyl methacrylate | 28 |
| Methacrylic acid | 2 |
| N-(Hydroxymethyl)acrylamide | 2 |

The solvent was initially charged in a jacketed reactor equipped with evaporative cooling, anchor stirrer and nitrogen inlet tube. The monomers were added to the initial charge during 4 hours at 120° C. together with 1.6 parts of tert-butyl peroxybenzoate free-radical initiator. On completion of the addition a further 0.3 part of the free-radical initiator was added every half an hour in one go. A transparent solution having a solids content of 20% was obtained after altogether 5.5 hours of polymerization time. The polymer had a weight average molar mass of 33 000, as determined by GPC. This polymer serves as comparative example.

### Example 7

### Preparation of an Ultrahydrophobicity-Conferring System of Polymer (O) and Particle (P)

In a dissolver of the DISPERMAT® CA40-M1 type from Getzmann GmbH, Reichshof, Germany, 2 g of a fumed hydrophilic silica of the HDK® V15 type (obtainable from Wacker Chemie AG, Munich, Germany) and 2 g of Kieselgel 60 silica gel [0.015-0.040 mm] (obtainable from Merck KgaA, Darmstadt, Germany) are dispersed in 100 mL of a 10% by weight solution of the polymer of Example 1 in methoxypropyl acetate. The system obtained is blade coated by means of a 90 μm blade onto a glass plate and stored at 140° C. for one hour to obtain an ultrahydrophobic surface having a static contact angle of 147°.

### Examples 8-20

### Preparation of Ultrahydrophobicity-Conferring Systems of Polymer (O) and Particle (P)

Example 7 was repeated to actualize the following systems:

| | Polymer | Particle | | |
|---|---|---|---|---|
| Example | (O) from | (P)* in | ratio | Contact |
| No. | Example | the ratio | (O)/(P) | angle |
| 8 | 1 | 1 + 2 (2/1) | 10/3 | 147° |
| 9 | 1 | 1 + 2 (3/1) | 10/4 | 139° |
| 10 | 1 | 1 + 2 (2/2) | 10/4 | 147° |
| 11 | 1 | 1 + 2 (2/3) | 10/5 | 144° |
| 12 | 2 | 1 + 2 (2/1) | 10/3 | 155° |
| 13 | 2 | 1 + 4 (2/1) | 10/3 | 160° |
| 14 | 3 | 1 + 2 (2/1) | 10/3 | 155° |
| 15 | 3 | 1 + 3 (2/1) | 10/3 | 152° |
| 16 | 3 | 1 + 4 (2/2) | 10/4 | 157° |
| 17 | 4 | 1 + 2 (2/2) | 10/4 | 158° |
| 18 | 4 | 1 + 3 (2/1) | 10/3 | 145° |
| 19 | 5 | 1 + 2 (2/2) | 10/4 | 154° |
| 20 | 6 | 1 + 2 (2/2) | 10/4 | 138° |
| VS1 | V1 | 1 + 2 (2/2) | 10/4 | 97° |
| VS2 | V1 | 1 + 3 (2/2) | 10/4 | 111° |

*1: HDK ® V15, Wacker Chemie AG, Munich, Germany
2: Kieselgel 60 silica gel [0.015-0.040 mm], Merck KgaA, Darmstadt, Germany
3: Kieselgel 60 silica gel [0.040-0.063 mm], Merck KgaA, Darmstadt, Germany
4: Celite ® 545, World Minerals Inc., Santa Barbara, California, USA

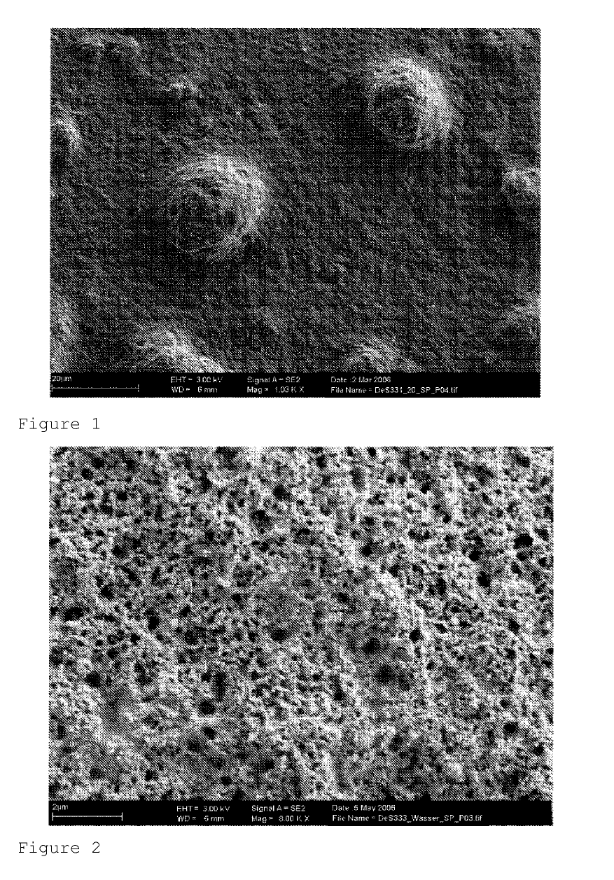

FIGS. 1 and 2 are scanning electron micrographs which show the surface of a system from Example 8 and illustrate the micro- and nanostructuring. Advancing and receding angles of all examples differ by less than 10°.

It is clear from the examples that the inventive systems of organosilicone copolymers (O) and hydrophilic particles (P) lead to ultrahydrophobic surfaces. There is no need for an at least partial hydrophobicization of the particles, contrary to the prior art. Comparative tests VS1 and VS2 show that a silicone-free polymer does not lead to the desired effects.

1.-10. (canceled)

11. A coating system comprising an organosilicone copolymer (O) prepared by free-radically polymerizing
A) one or more ethylenically unsaturated monomers selected from the group consisting of (meth)acrylic esters, vinyl esters, vinylaromatics, olefins, 1,3-dienes and vinyl ethers, and
B) one or more monoethylenically or polyethylenically unsaturated polyorganosiloxanes, and
C) optionally ethylenically unsaturated auxiliary monomers, and
D) further containing hydrophilic particles (P).

12. The coating system of claim 11, wherein the monomer(s) are selected from the group consisting of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene and 1,3-butadiene.

13. The coating system of claim 11, wherein the mono- or polyethylenically unsaturated polyorganosiloxane(s) B) have the formula [1]
(SiO_{4/2})ₖ(R¹SiO_{3/2})ₘ(R¹₂SiO_{2/2})ₚ(R¹₃SiO_{1/2})_{q}[O_{1/2}SiR³₂-L-X]ₛ[O_{1/2}H]ₜ [1]
where
L represents a bivalent optionally substituted aromatic, heteroaromatic or aliphatic radical (CR⁴₂)_{b},
R¹, R³, R⁴ each independently represent a hydrogen atom or a monovalent optionally —CN—, —NCO—, —NR²₂—, —COOH—, —COOR²—, —PO(OR²)₂—, -halogen-, -acryloyl-, -epoxy-, —SH—, —OH— or —CONR²₂-substituted C₁-C₂₀ hydrocarbyl radical or C₁-C₂₀ hydrocarbyloxy radical in which one or more mutually nonadjacent methylene units are optionally replaced by group(s) —O—, —CO—, —COO—, —OCO— or —OCOO—, —S—, or —NR²— and in each of which one or more mutually nonadjacent methine units are optionally replaced by groups —N═, —N═N—, or —P═,
X represents an ethylenically unsaturated radical,
R² represents hydrogen or a monovalent optionally substituted hydrocarbyl radical,
b represents 0 or a positive integer,
s represents an integer of at least 1,
t represents 0 or a positive integer, and
k+m+p+q is an integer of at least 2.

14. The coating system of claim 12, wherein the mono- or polyethylenically unsaturated polyorganosiloxane(s) B) have the formula [1]
(SiO_{4/2})ₖ(R¹SiO_{3/2})ₘ(R¹₂SiO_{2/2})ₚ(R¹₃SiO_{1/2})_{q}[O_{1/2}SiR³₂-L-X]ₛ[O_{1/2}H]ₜ [1]
where
L represents a bivalent optionally substituted aromatic, heteroaromatic or aliphatic
radical (CR⁴₂)_{b},
R¹, R³, R⁴ each independently represent a hydrogen atom or a monovalent optionally —CN—, —NCO—, —NR²₂—, —COOH—, —COOR²—, —PO(OR²)₂—, -halogen-, -acryloyl-, -epoxy-, —SH—, —OH— or —CONR²₂-substituted C₁-C₂₀ hydrocarbyl radical or C₁-C₂₀ hydrocarbyloxy radical in which one or more mutually nonadjacent methylene units are optionally replaced by group(s) —O—, —CO—, —COO—, —OCO— or —OCOO—, —S—, or —NR²— and in each of which one or more mutually nonadjacent methine units are optionally replaced by groups —N═, —N═N—, or —P═,
X represents an ethylenically unsaturated radical,
R² represents hydrogen or a monovalent optionally substituted hydrocarbyl radical,
b represents 0 or a positive integer,
s represents an integer of at least 1,
t represents 0 or a positive integer, and
k+m+p+q is an integer of at least 2.

15. The coating system of claim 13, wherein k and m are each 0 and q is 0 or 1.

16. The coating system of claim 11, wherein at least 50 parts by weight of monomer A) are used per 100 parts by weight of the ethylenically unsaturated monomers A), B) and C).

17. The coating system of claim 11, wherein 1 to 50 parts by weight of monomer B) are used per 100 parts by weight of the ethylenically unsaturated monomers A), B) and C).

18. The coating system of claim 16, wherein 1 to 50 parts by weight of monomer B) are used per 100 parts by weight of the ethylenically unsaturated monomers A), B) and C).

19. The coating system of claim 11, wherein particle(s) (P) are selected from the group consisting of hydrophilic silicon oxides and metal oxides MO of the metals aluminum, titanium, zirconium, tantalum, tungsten, hafnium, zinc and tin.

20. The coating system of claim 11, wherein the mass ratio of polymers (O)/particles (P) is in the range from 10/1 to 10/8.

21. A process for producing a coating system of claim 11, comprising incorporating particles (P) into a solution or dispersion of the polymer (O).

22. A hydrophobic coating prepared by applying the coating system of claim 11 to a substrate.
